(19) United States
(12) Patent Application Publication
(10) Pub. No.: US 2026/0034851 A1
(43) Pub. Date: Feb. 5, 2026

(54) VEHICLE

(71) Applicant: SUBARU CORPORATION, Tokyo (JP)

(72) Inventor: Kazufumi SUZUKI, Tokyo (JP)

(21) Appl. No.: 19/235,781

(22) Filed: Jun. 12, 2025

(30) Foreign Application Priority Data
Jul. 31, 2024 (JP) 2024-125009

(51) Int. Cl. B60H 1/00

(52) U.S. Cl. CPC B60H 1/00657; B60H 1/00807

(57) ABSTRACT

A vehicle includes an air conditioner, a calculator, and a controller. The air conditioner is configured to adjust a temperature inside a vehicle compartment of the vehicle to a set temperature set by a user. The calculator is configured to calculate a change in the temperature inside the vehicle compartment to reach the set temperature, based on a temperature outside the vehicle compartment and the temperature inside the vehicle compartment. The controller is configured to cause information on the change in the temperature inside the vehicle compartment to be notified to the user.

### CROSS-REFERENCE TO RELATED APPLICATIONS

The present application claims priority from Japanese Patent Application No. 2024-125009 filed on Jul. 31, 2024, the entire contents of which are hereby incorporated by reference.

### BACKGROUND

The disclosure relates to a vehicle.

A vehicle configured to activate an air conditioner mounted in the vehicle by remote operation has been put into practical use.

Japanese Unexamined Patent Application Publication (JP-A) No. 2004-256092, for example, discloses a technique of controlling one or both of air ventilation and an air conditioner inside a vehicle compartment when a temperature inside the vehicle compartment is to be lowered by activating the air conditioner.

### SUMMARY

An aspect of the disclosure provides a vehicle including an air conditioner, a calculator, and a controller. The air conditioner is configured to adjust a temperature inside a vehicle compartment of the vehicle to a set temperature set by a user. The calculator is configured to calculate a change in the temperature inside the vehicle compartment to reach the set temperature, based on a temperature outside the vehicle compartment and the temperature inside the vehicle compartment. The controller is configured to cause information on the change in the temperature inside the vehicle compartment to be notified to the user.

An aspect of the disclosure provides a vehicle including a processing apparatus and an air conditioner configured to adjust a temperature inside a vehicle compartment of the vehicle to a set temperature set by a user. The processing apparatus includes one or more processors, and one or more memories communicably coupled to the one or more processors. The one or more processors are configured to calculate a change in the temperature inside the vehicle compartment to reach the set temperature, based on a temperature outside the vehicle compartment and the temperature inside the vehicle compartment, and cause information on the change in the temperature inside the vehicle compartment to be notified to the user.

### BRIEF DESCRIPTION OF THE DRAWINGS

The accompanying drawings are included to provide a further understanding of the disclosure and are incorporated in and constitute a part of this specification. The drawings illustrate example embodiments and, together with the specification, serve to explain the principles of the disclosure.

FIG. 1 is a block diagram illustrating an exemplary configuration of a vehicle according to one example embodiment of the disclosure.

FIG. 2 is a diagram illustrating an example of information to be displayed on a screen of a user terminal when a user sets a temperature on an air conditioner of the vehicle illustrated in FIG. 1.

FIG. 3 is a block diagram illustrating exemplary configurations of a processing apparatus and a processor of the vehicle illustrated in FIG. 1.

FIG. 4 is a table illustrating an example of information on a change in temperature inside a vehicle compartment calculated by the vehicle illustrated in FIG. 1.

FIG. 5 is a diagram illustrating an exemplary image of the information on the change in temperature that the vehicle illustrated in FIG. 1 is to display on the user terminal.

FIG. 6 is a flowchart of a process to be executed by the vehicle illustrated in FIG. 1.

FIG. 7 is a block diagram illustrating an exemplary configuration of a vehicle according to one example embodiment of the disclosure.

FIG. 8 is a block diagram illustrating exemplary configurations of a processing apparatus and a processor of the vehicle illustrated in FIG. 7.

FIG. 9 is a diagram illustrating an exemplary image of information on a change in temperature that the vehicle illustrated in FIG. 7 is to display on the user terminal.

FIG. 10 is a flowchart of a process to be performed by the vehicle illustrated in FIG. 7.

FIG. 11 is a block diagram illustrating an exemplary configuration of a vehicle according to one example embodiment of the disclosure.

FIG. 12 is a block diagram illustrating exemplary configurations of a processing apparatus and a processor of the vehicle illustrated in FIG. 11.

FIG. 13 is a diagram illustrating an exemplary image of information on a change in temperature that the vehicle illustrated in FIG. 11 is to display on the user terminal.

FIG. 14 is a flowchart of a process to be executed by the vehicle illustrated in FIG. 11.

### DETAILED DESCRIPTION

An existing technique disclosed in, for example, JP-A No. 2004-256092 fails to notify a user of information on a change in temperature inside a vehicle compartment to reach a temperature set by a user. This can hinder the user from determining when to board the vehicle.

It is desirable to provide a vehicle configured to notify a user of information on a change in temperature inside a vehicle compartment upon activation of an air conditioner mounted in the vehicle.

### Example Embodiments

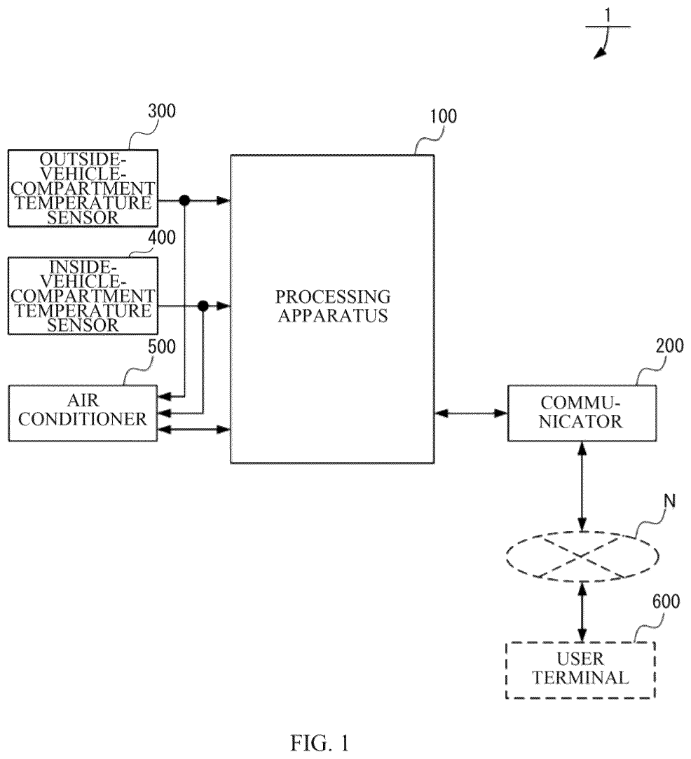

Some example embodiments of the disclosure will be described with reference to FIGS. 1 to 14.

### First Example Embodiment

A vehicle 1 according to a first example embodiment will now be described with reference to FIGS. 1 to 6.

### <Configuration of Vehicle 1>

As illustrated in FIG. 1, the vehicle 1 according to the present example embodiment may include a processing apparatus 100, a communicator 200, an outside-vehicle-compartment temperature sensor 300, an inside-vehicle-compartment temperature sensor 400, and an air conditioner 500.

Note that an exemplary configuration of the processing apparatus 100 will be described in detail later.

In the present example embodiment, the communicator 200 may include a known wireless communication module, and may serve as an interface configured to communicate with a user terminal 600 via a network N, for example.

The network N may be, for example but not limited to, the Internet.

The user terminal 600 may be, for example but not limited to, a smartphone or a tablet.

In the present example embodiment, the communicator 200 may further include a known module using near field communication such as Bluetooth (registered trademark) or Wi-Fi (registered trademark), and may serve as an interface configured to communicate with the user terminal 600.

In the present example embodiment, when being capable of communicating with the user terminal 600 via the near field communication, the communicator 200 may communicate with the user terminal 600 without the network N.

In the present example embodiment, the communicator 200 may output a request to activate the air conditioner 500 and set temperature information received from the user terminal 600 to the processing apparatus 100.

In the present example embodiment, the communicator 200 may transmit information on a change in temperature inside a vehicle compartment of the vehicle 1 to the user terminal 600 under the control by the processing apparatus 100.

The user terminal 600 configured to communicate with the communicator 200 will now be described.

In the present example embodiment, the user may send the vehicle 1 the request to activate the air conditioner 500 and the set temperature information by operating the user terminal 600.

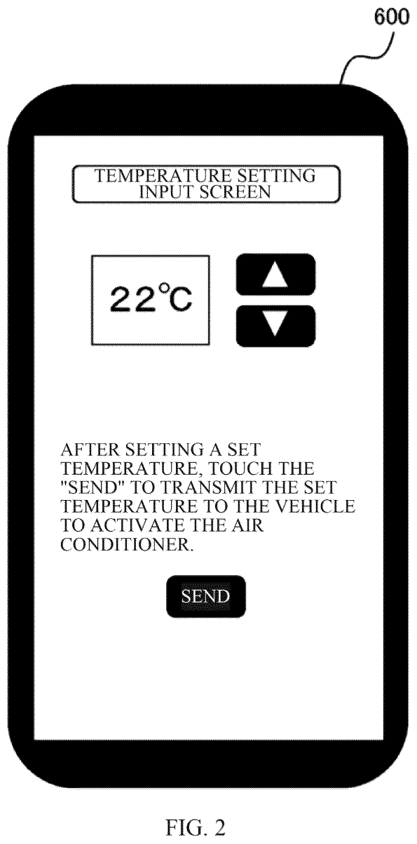

In the present example embodiment, the user terminal 600 may display a temperature setting input screen illustrated in FIG. 2 when application software for setting a temperature on the air conditioner 500 is activated by an operation by the user.

After inputting the set temperature inside the vehicle compartment, the user may touch a send button displayed on the temperature setting input screen to transmit the set temperature information to the vehicle 1.

In the present example embodiment, the user terminal 600 may transmit the request to activate the air conditioner 500 and the set temperature information to the vehicle 1 when determining that the send button has been touched.

In the present example embodiment, when receiving the information on the change in temperature inside the vehicle compartment via the communicator 200 of the vehicle 1, the user terminal 600 may display the information on the change in temperature inside the vehicle compartment on an unillustrated display unit of the user terminal 600.

Note that the information on the change in temperature inside the vehicle compartment will be described later.

In the present example embodiment, the outside-vehicle-compartment temperature sensor 300 may be disposed outside the vehicle compartment of the vehicle 1, and may output outside-vehicle-compartment temperature information on a temperature outside the vehicle compartment of the vehicle 1.

In the present example embodiment, the outside-vehicle-compartment temperature sensor 300 may output the outside-vehicle-compartment temperature information to the processing apparatus 100 and the air conditioner 500 to be described later.

In the present example embodiment, the inside-vehicle-compartment temperature sensor 400 may be disposed inside the vehicle compartment of the vehicle 1, and may output inside-vehicle-compartment temperature information on a temperature inside the vehicle compartment of the vehicle 1.

In the present example embodiment, the inside-vehicle-compartment temperature sensor 400 may output the inside-vehicle-compartment temperature information to the processing apparatus 100 and the air conditioner 500 to be described later.

The air conditioner 500 may adjust the temperature inside the vehicle compartment to the set temperature set by the user.

In the present example embodiment, when receiving the request to activate the air conditioner 500 and the set temperature information from the processing apparatus 100, the air conditioner 500 may control the temperature inside the vehicle compartment of the vehicle 1, based on the outside-vehicle-compartment temperature information received from the outside-vehicle-compartment temperature sensor 300, the inside-vehicle-compartment temperature information received from the inside-vehicle-compartment temperature sensor 400, and the set temperature information received from the processing apparatus 100.

In the present example embodiment, the air conditioner 500 may adjust the temperature inside the vehicle compartment to the set temperature set by the user by switching a driving mode between a cooling mode and a heating mode.

In the present example embodiment, the air conditioner 500 may adjust the temperature inside the vehicle compartment to the set temperature set by the user by controlling parameters such as switching between outside-air introduction and inside-air circulation, switching between air blowout ports, or an air blast volume.

### <Configuration of Processing Apparatus 100>

The processing apparatus 100 includes one or more processors and one or more memories communicably coupled to the one or more processors.

In the present example embodiment, the processing apparatus 100 may include a processor 110 and a memory 120, as illustrated in FIG. 3.

Note that an exemplary configuration of the processor 110 will be described later.

The memory 120 may include an unillustrated read only memory (ROM) and an unillustrated random-access memory (RAM).

The memory 120 may hold, for example but not limited to, a control program and various kinds of data received from the processor 110.

In the present example embodiment, the memory 120 may hold in advance, for example but not limited to, information on output performance of the air conditioner 500.

### <Configuration of Processor 110>

As illustrated in FIG. 3, the processor 110 includes a temperature change calculator 111 and a controller 112. In one embodiment, the temperature change calculator 111 may serve as a “calculator”.

The components in the processor 110, the memory 120, and the communicator 200 may send and receive various kinds of information via a bus line BL.

The temperature change calculator 111 calculates a change in the temperature inside the vehicle compartment to reach the set temperature, based on the temperature outside the vehicle compartment and the temperature inside the vehicle compartment.

In the present example embodiment, when receiving a request to calculate the change in temperature and the set temperature information from the controller 112 via the bus line BL, the temperature change calculator 111 may calculate the change in temperature to reach the set temperature, based on the outside-vehicle-compartment temperature information received from the outside-vehicle-compartment temperature sensor 300, the inside-vehicle-compartment temperature information received from the inside-vehicle-compartment temperature sensor 400, and the set temperature information received from the controller 112.

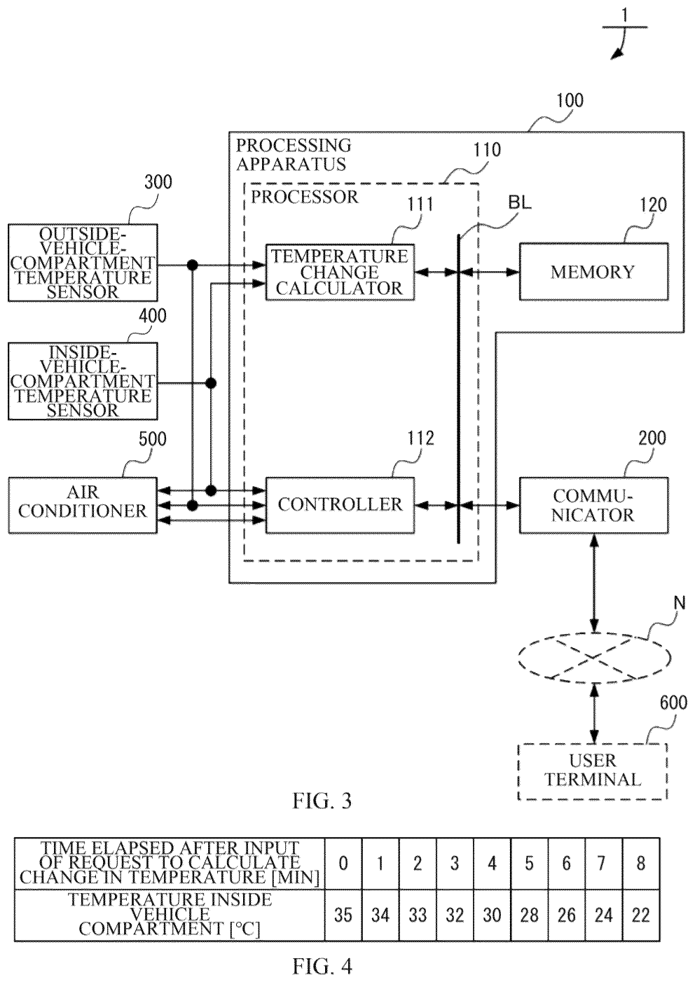

In the present example embodiment, the temperature change calculator 111 may calculate the change in temperature inside the vehicle compartment over a predetermined time (e.g., one minute) from the reception of the request to calculate the change in temperature from the controller 112, as illustrated in FIG. 4, for example.

In the present example embodiment, the temperature change calculator 111 may calculate an effect of heating or cooling by the air conditioner 500 (e.g., heat variation amount per unit time), based on the information on the output performance of the air conditioner 500 held in the memory 120, for example.

In the present example embodiment, the temperature change calculator 111 may calculate a heat loss in the vehicle 1, for example.

In the present example embodiment, the temperature change calculator 111 may calculate the amount of change in the temperature inside the vehicle compartment per unit time, based on the result of calculation described above and an effect of the outside-vehicle-compartment temperature.

In the present example embodiment, the temperature change calculator 111 may output the result of calculation to the controller 112, which will be described later, via the bus line BL, for example.

The temperature change calculator 111 may employ any other method of calculating the change in temperature inside the vehicle compartment to reach the set temperature than the method described above.

In the present example embodiment, when receiving the request to activate the air conditioner 500 and the set temperature information from the user terminal 600 via the communicator 200, for example, the controller 112 may output the request to activate the air conditioner 500 and the set temperature information to the air conditioner 500.

In the present example embodiment, when receiving the request to activate the air conditioner 500 and the set temperature information from the user terminal 600 via the communicator 200, for example, the controller 112 may output the request to calculate the change in temperature and the set temperature information to the temperature change calculator 111.

The controller 112 may cause the information on the change in temperature inside the vehicle compartment to be notified to the user.

In the present example embodiment, the controller 112 may generate display information by visualizing the result of calculation received from the temperature change calculator 111, and transmit the display information thus generated to the user terminal 600 via the communicator 200.

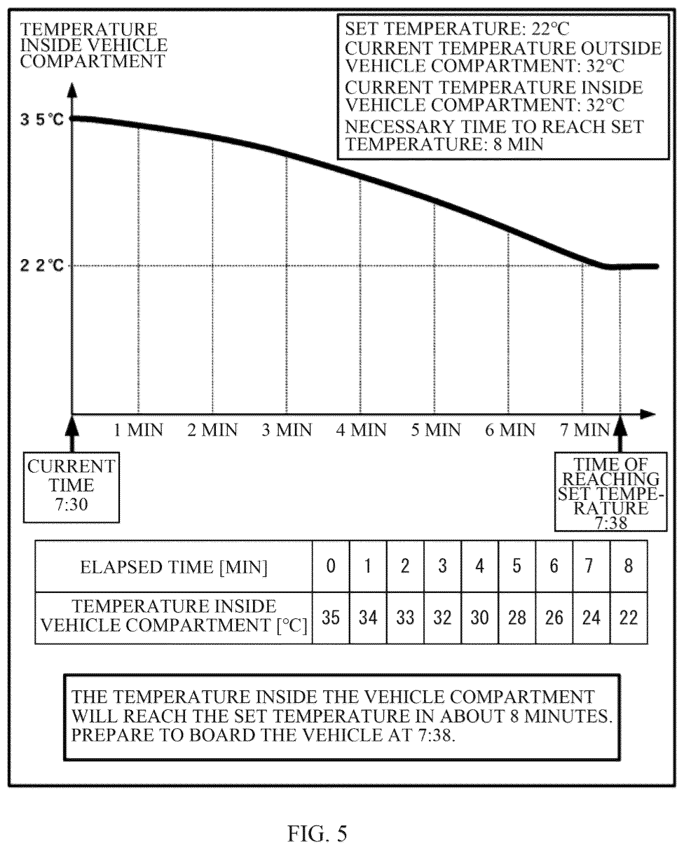

An exemplary image of the information (the information on the change in temperature inside the vehicle compartment) that the controller 112 causes the user terminal 600 to display will now be described with reference to FIG. 5.

In the present example embodiment, the controller 112 may cause the user terminal 600 to display the set temperature information (e.g., 22° C.) received from the user terminal 600. In the present example embodiment, the controller 112 may cause the user terminal 600 to display the outside-vehicle-compartment temperature information (e.g., 32° C.) received from the outside-vehicle-compartment temperature sensor 300 upon the request to activate the air conditioner 500 being outputted.

In the present example embodiment, the controller 112 may cause the user terminal 600 to display the inside-vehicle-compartment temperature information (e.g., 35° C.) received from the inside-vehicle-compartment temperature sensor 400 upon the request to activate the air conditioner 500 being outputted.

In the present example embodiment, the controller 112 may cause the user terminal 600 to display a time (e.g., eight minutes) necessary for the temperature inside the vehicle compartment to reach the set temperature set by the user.

In the present example embodiment, the controller 112 may cause the user terminal 600 to display the temperature inside the vehicle compartment per unit time received from the temperature change calculator 111 and a visualized graph of the temperature inside the vehicle compartment per unit time.

In some embodiments, the temperature inside the vehicle compartment per unit time may be displayed in the form of a table indicating the temperature inside the vehicle compartment per unit time.

In the present example embodiment, the controller 112 may cause the user terminal 600 to display information on the time of reception of the request to activate the air conditioner 500 from the user terminal 600 (e.g., 7:30) and information on the time of reaching of the temperature inside the vehicle compartment to the set temperature set by the user (e.g., 7:38). In the present example embodiment, the controller 112 may cause the user terminal 600 to display the following comment: “The temperature inside the vehicle compartment will reach the set temperature in about eight minutes. Prepare to board the vehicle at 7:38.”

### <Flow of Process to be Executed by Vehicle 1>

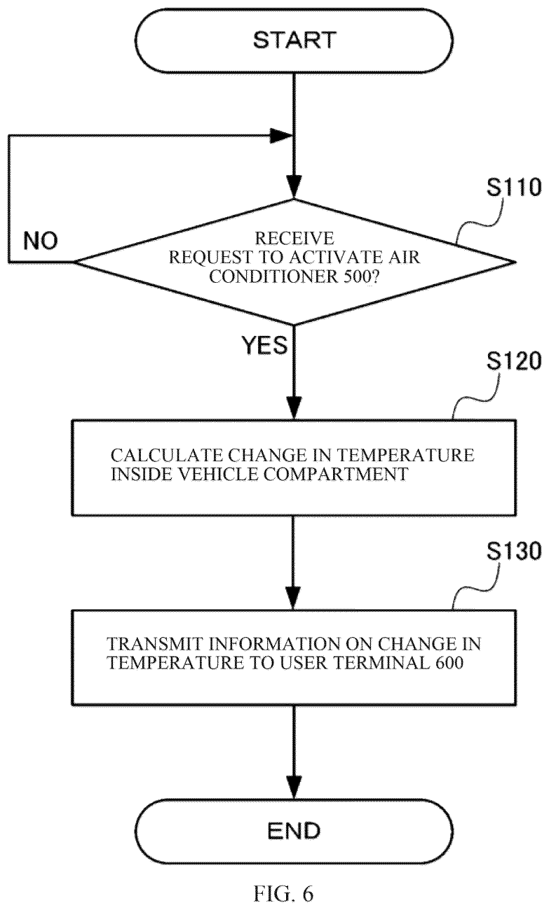

An exemplary flow of the process to be executed by the vehicle 1 will now be described with reference to FIG. 6.

The controller 112 may determine whether the request to activate the air conditioner 500 has been received from the user terminal 600 (Step S110).

If determining that the request to activate the air conditioner 500 has not been received from the user terminal 600 (Step S110: NO), the controller 112 may return the process to a stand-by mode.

If determining that the request to activate the air conditioner 500 has been received from the user terminal 600 (Step S110: YES), the controller 112 may cause the process to proceed to Step S120.

The controller 112 may cause the temperature change calculator 111 to calculate the change in temperature inside the vehicle compartment (Step S120) and cause the process to proceed to Step S130.

The controller 112 may transmit the information on the change in temperature inside the vehicle compartment to the user terminal 600 via the communicator 200 (Step S140) and end the process.

The user terminal 600 may cause the display unit of the user terminal 600 to display the information on the change in temperature inside the vehicle compartment received from the vehicle 1.

### <Workings and Effects>

As described above, the vehicle 1 according to the present example embodiment includes the air conditioner 500, the temperature change calculator 111, and the controller 112. The air conditioner 500 adjusts the temperature inside the vehicle compartment to the set temperature set by the user. The temperature change calculator 111 calculates the change in temperature inside the vehicle compartment to reach the set temperature, based on the temperature outside the vehicle compartment and the temperature inside the vehicle compartment. The controller 112 causes the information on the change in temperature to be notified to the user.

That is, when the air conditioner 500 is activated, the vehicle 1 calculates the change in temperature inside the vehicle compartment to reach the set temperature set by the user, based on the temperature outside the vehicle compartment of the vehicle 1 and the temperature inside the vehicle compartment of the vehicle 1, and causes the user terminal 600 to display the information on the change in temperature inside the vehicle compartment. Accordingly, the vehicle 1 makes it possible to notify the user of the information on the time necessary for the temperature inside the vehicle compartment to reach the set temperature.

This allows the user to determine when to board the vehicle 1 by referring to the information on the change in temperature inside the vehicle compartment displayed on the user terminal 600.

The controller 112 of the vehicle 1 according to the present example embodiment may cause the visualized information on the temperature inside the vehicle compartment of the vehicle 1 to be notified to the user.

The vehicle 1 may cause the user terminal 600 to display the set temperature set by the user as the information on the change in temperature.

The vehicle 1 may cause the user terminal 600 to display the temperature inside the vehicle compartment of the vehicle 1 at the time of reception of the request to activate the air conditioner 500 from the user terminal 600 as the information on the change in temperature.

The vehicle 1 may cause the user terminal 600 to display the time necessary for the temperature inside the vehicle compartment to reach the set temperature set by the user as the information on the change in temperature.

The vehicle 1 may cause the user terminal 600 to display the temperature outside the vehicle compartment of the vehicle 1 at the time of reception of the request to activate the air conditioner 500 from the user terminal 600 as the information on the change in temperature on the user terminal 600.

The vehicle 1 may cause the user terminal 600 to display the temperature inside the vehicle compartment per unit time after the activation of the air conditioner 500 and the visualized graph of the temperature inside the vehicle compartment per unit time as the information on the change in temperature.

The vehicle 1 may cause the user terminal 600 to display the information on the time of reception of the request to activate the air conditioner 500 from the user terminal 600 and the information on the time of reaching of the temperature inside the vehicle compartment to the set temperature set by the user as the information on the change in temperature.

Displaying the change in temperature inside the vehicle compartment on the user terminal 600 in such a visualized manner allows the user to recognize the details of the change in temperature inside the vehicle compartment.

This allows the user to easily determine when to board the vehicle 1.

The controller 112 of the vehicle 1 according to the present example embodiment may cause the user terminal 600 to display the information on the change in temperature upon receiving the request to activate the air conditioner 500 from the user terminal 600 owned by the user.

In a cold season, for example, the user is allowed to remotely activate the air conditioner 500 in the vehicle 1 by operating the user terminal 600 in the home, and to board the vehicle 1 after heating the vehicle compartment.

That is, the vehicle 1 makes it possible to notify the user waiting in the home or other places of the information on the change in temperature inside the vehicle compartment.

This allows the user to easily determine when to board the vehicle 1.

In some embodiments, the vehicle 1 may cause the user terminal 600 to display the following comment: “The temperature inside the vehicle compartment will reach the set temperature in about eight minutes. Prepare to board the vehicle at 7:38.”

This allows the user to board the vehicle 1 at an appropriate timing when the temperature inside the vehicle compartment reaches the set temperature.

Since the user is recommended to board the vehicle 1 at the time of reaching of the temperature inside the vehicle compartment to the set temperature, it is possible to reduce the waiting time in the home.

This helps to reduce the energy to be wastefully consumed from the time of reaching of the temperature inside the vehicle compartment to the set temperature to the time of start of traveling of the vehicle 1, resulting in reductions in CO₂ emission, electric consumption, and fuel consumption.

In some embodiments, the vehicle 1 may cause the user terminal 600 to display the temperature inside the vehicle compartment per unit time after the activation of the air conditioner 500 and the visualized graph of the temperature inside the vehicle compartment per unit time.

This allows the user to determine whether the temperature inside the vehicle compartment has reached an allowable temperature lower than the set temperature. It is therefore possible for the user to board the vehicle 1 at a desired timing before the temperature inside the vehicle compartment reaches the set temperature.

### Second Example Embodiment

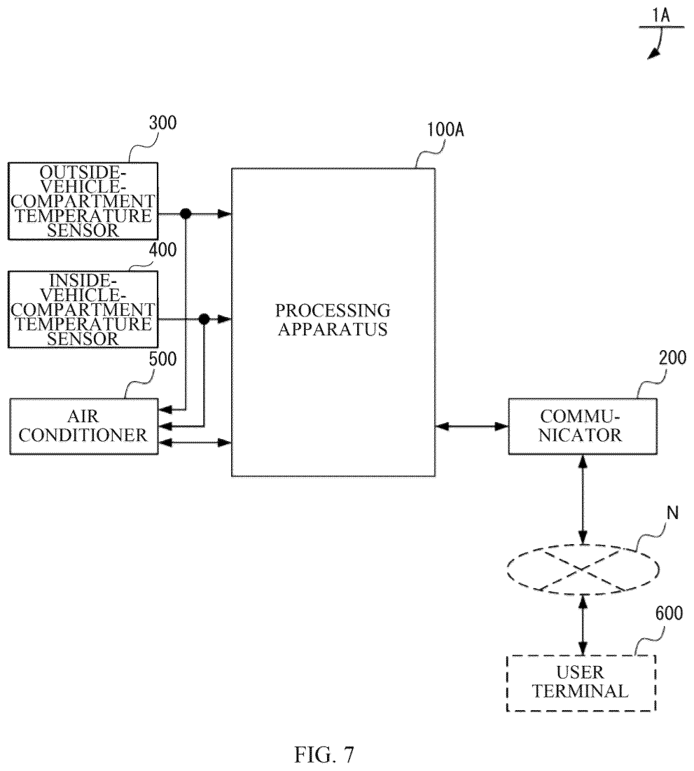

A vehicle 1A according to a second example embodiment will now be described with reference to FIGS. 7 to 10.

Note that the elements denoted with the same reference numerals as those in the first example embodiment have configurations similar to those in the first example embodiment, and a description thereof is omitted.

### <Configuration of Vehicle 1A>

As illustrated in FIG. 7, the vehicle 1A according to the present example embodiment may include a processing apparatus 100A, the communicator 200, the outside-vehicle-compartment temperature sensor 300, the inside-vehicle-compartment temperature sensor 400, and the air conditioner 500.

### <Configuration of Processing Apparatus 100A>

The processing apparatus 100A includes one or more processors and one or more memories communicably coupled to the one or more processors.

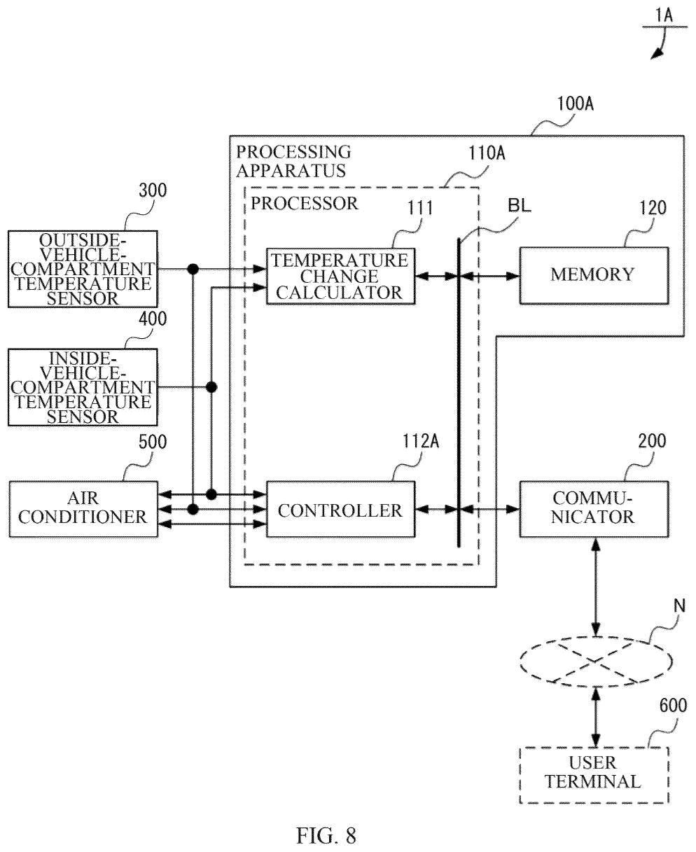

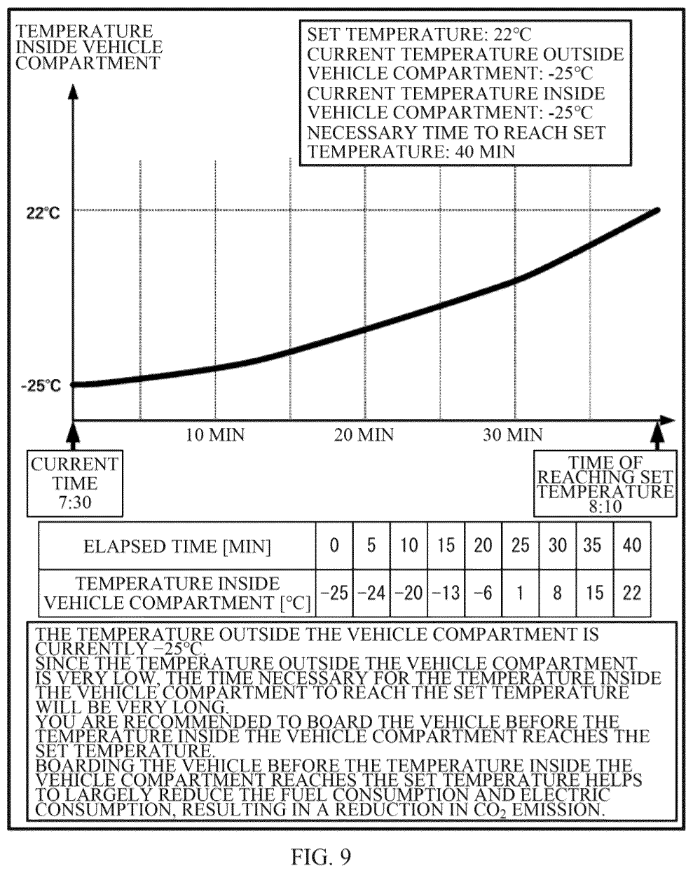

In the present example embodiment, the processing apparatus 100A may include a processor 110A and the memory 120, as illustrated in FIG. 8.

### <Configuration of Processor 110A>

As illustrated in FIG. 8, the processor 110A includes the temperature change calculator 111 and a controller 112A.

The components in the processor 110A, the memory 120, and the communicator 200 may send and receive various kinds of information via the bus line BL.

In the present example embodiment, when receiving the request to activate the air conditioner 500 and the set temperature information from the user terminal 600 via the communicator 200, the controller 112A may output the request to activate the air conditioner 500 and the set temperature information to the air conditioner 500.

In the present example embodiment, when receiving the request to activate the air conditioner 500 and the set temperature information from the user terminal 600 via the communicator 200, the controller 112A may output the request to calculate the change in temperature and the set temperature information to the temperature change calculator 111.

In the present example embodiment, the controller 112A may generate the display information by visualizing the result of calculation received from the temperature change calculator 111.

If the temperature outside the vehicle compartment is lower than a predetermined temperature, the controller 112A may calculate the amount of change in temperature inside the vehicle compartment per unit time. If the amount of change in temperature per unit time is less than or equal to a predetermined amount of change, the controller 112A may cause the display information (information on the change in temperature) generated as described above and information recommending the user to board the vehicle 1A before the temperature inside the vehicle compartment reaches the set temperature to be notified to the user.

In the present example embodiment, when receiving the request to activate the air conditioner 500 and the set temperature information from the user terminal 600, the controller 112A may determine whether the temperature outside the vehicle compartment is lower than a predetermined temperature (e.g., −20° C.), by referring to the outside-vehicle-compartment temperature information received from the outside-vehicle-compartment temperature sensor 300.

In the present example embodiment, the controller 112A may determine whether the amount of change in temperature in ten minutes after the activation of the air conditioner 500 is less than or equal to 15° C., by referring to the information on the change in temperature inside the vehicle compartment received from the temperature change calculator 111.

In the present example embodiment, if determining that the temperature outside the vehicle compartment is lower than the predetermined temperature (e.g., −20° C.) and that the amount of change in temperature per unit time (e.g., in ten minutes after the activation of the air conditioner 500) is less than or equal to the predetermined amount of change (e.g., 15° C.), the controller 112A may transmit the visualized information on the change in temperature inside the vehicle compartment and the information recommending the user to board the vehicle 1A before the temperature in the vehicle compartment reaches the set temperature set by the user to the user terminal 600 via the communicator 200.

An exemplary image of the information that the controller 112A causes the user terminal 600 to display will now be described with reference to FIG. 9.

In the present example embodiment, the controller 112A may cause the user terminal 600 to display the set temperature (e.g., 22° C.) received from the user terminal 600.

In the present example embodiment, the controller 112A may cause the user terminal 600 to display the outside-vehicle-compartment temperature information (e.g., −25° C.) received from the outside-vehicle-compartment temperature sensor 300 upon the request to activate the air conditioner 500 being outputted.

In the present example embodiment, the controller 112A may cause the user terminal 600 to display the inside-vehicle-compartment temperature information (e.g., −25° C.) received from the inside-vehicle-compartment temperature sensor 400 upon the request to activate the air conditioner 500 being outputted.

In the present example embodiment, the controller 112A may cause the user terminal 600 to display a time (e.g., 40 minutes) necessary for the temperature inside the vehicle compartment to reach the set temperature set by the user.

In the present example embodiment, the controller 112A may cause the user terminal 600 to display the temperature inside the vehicle compartment per unit time received from the temperature change calculator 111 and a visualized graph of the temperature inside the vehicle compartment per unit time.

In some embodiments, the temperature inside the vehicle compartment per unit time may be displayed in the form of a table indicating the temperature inside the vehicle compartment per unit time.

In the present example embodiment, the controller 112A may cause the user terminal 600 to display the information on the time of reception of the request to activate the air conditioner 500 from the user terminal 600 and the information on the time of reaching of the temperature inside the vehicle compartment to the set temperature set by the user.

In the present example embodiment, the controller 112A may cause the user terminal 600 to display the following comment: “The temperature outside the vehicle compartment is currently −25° C. Since the temperature outside the vehicle compartment is very low, the time necessary for the temperature inside the vehicle compartment to reach the set temperature will be very long. You are recommended to board the vehicle before the temperature inside the vehicle compartment reaches the set temperature. Boarding the vehicle before the temperature inside the vehicle compartment reaches the set temperature helps to largely reduce the fuel consumption and electric consumption, resulting in a reduction in CO₂ emission.”

### <Flow of Process to be Executed by Vehicle 1A>

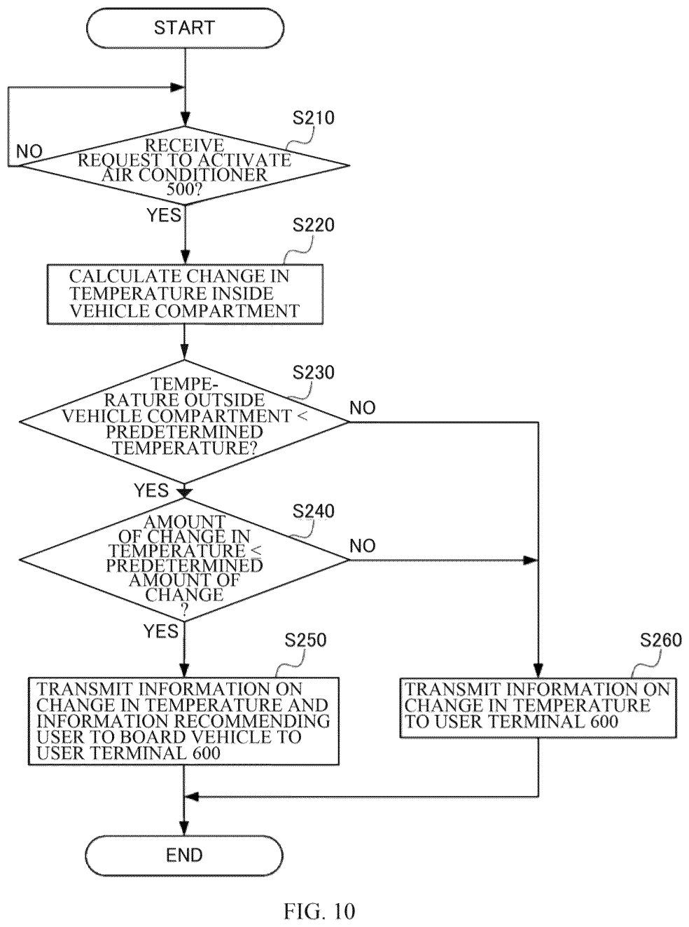

An exemplary flow of the process to be executed by the vehicle 1A will now be described with reference to FIG. 10.

The controller 112A may determine whether the request to activate the air conditioner 500 has been received from the user terminal 600 (Step S210).

If determining that the request to activate the air conditioner 500 has not been received from the user terminal 600 (Step S210: NO), the controller 112A may return the process to a stand-by mode.

If determining that the request to activate the air conditioner 500 has been received from the user terminal 600 (Step S210: YES), the controller 112A may cause the process to proceed to Step S220.

The controller 112A may cause the temperature change calculator 111 to calculate the change in temperature inside the vehicle compartment (Step S220) and cause the process to proceed to Step S230.

The controller 112A may determine whether the temperature outside the vehicle compartment is lower than the predetermined temperature, based on the outside-vehicle-compartment temperature information received from the outside-vehicle-compartment temperature sensor 300 (Step S230).

If determining that the temperature outside the vehicle compartment is lower than the predetermined temperature, based on the outside-vehicle-compartment temperature information received from the outside-vehicle-compartment temperature sensor 300 (Step S230: YES), the controller 112A may cause the process to proceed to Step S240.

If determining that the temperature outside the vehicle compartment is not lower than the predetermined temperature, based on the outside-vehicle-compartment temperature information received from the outside-vehicle-compartment temperature sensor 300 (Step S230: NO), the controller 112A may cause the process to proceed to Step S260.

The controller 112A may determine whether the amount of change in temperature per unit time is less than or equal to the predetermined amount of change, based on the change in temperature inside the vehicle compartment calculated in Step S220 (Step S240).

If determining that the amount of change in temperature per unit time is less than or equal to the predetermined amount of change, based on the change in temperature inside the vehicle compartment calculated in Step S220 (Step S240: YES), the controller 112A may cause the process to proceed to Step S250.

If determining that the amount of change in temperature per unit time is not less than or equal to the predetermined amount of change, based on the change in temperature inside the vehicle compartment calculated in Step S220 (Step S240: NO), the controller 112A may cause the process to proceed to Step S260.

If determining that the amount of change in temperature per unit time is less than or equal to the predetermined amount of change, based on the change in temperature inside the vehicle compartment calculated in Step S220 (Step S240: YES), the controller 112A may transmit the information on the change in temperature inside the vehicle compartment and the information recommending the user to board the vehicle 1A before the temperature inside the vehicle compartment reaches the set temperature, to the user terminal 600 via the communicator 200 (Step S250), and thereafter end the process.

If determining that the temperature outside the vehicle compartment is not lower than the predetermined temperature, based on the outside-vehicle-compartment temperature information received from the outside-vehicle-compartment temperature sensor 300 (Step S230: NO), or if determining that the amount of change in temperature per unit time is not less than or equal to the predetermined amount of change, based on the change in temperature inside the vehicle compartment calculated in Step S220 (Step S240: NO), the controller 112A may transmit the information on the change in temperature inside the vehicle compartment to the user terminal 600 via the communicator 200 (Step S260), and thereafter end the process.

### <Workings and Effects>

As described above, if the temperature outside the vehicle compartment is lower than the predetermined temperature, the controller 112A of the vehicle 1A according to the present example embodiment may cause the temperature change calculator 111 to calculate the amount of change in temperature inside the vehicle compartment per unit time. If the amount of change in temperature inside the vehicle compartment per unit time is less than or equal to the predetermined amount of change, the controller 112A may cause the information recommending the user to board the vehicle 1A before the temperature inside the vehicle compartment reaches the set temperature to be notified to the user.

In a case where the air conditioner 500 of the vehicle 1A is activated when being parked in a very low temperature environment outside the vehicle compartment (e.g., −20° C. or less), the time necessary for the temperature inside the vehicle compartment to reach the set temperature will be very long due to an influence of the outside temperature.

In addition, when the temperature outside the vehicle compartment is very low, it can be difficult to raise the temperature inside the vehicle compartment to the temperature set by the user, depending on the output performance of the air conditioner 500.

Accordingly, when the temperature outside the vehicle compartment is less than or equal to −20° C., the vehicle 1A may calculate the amount of change in temperature inside the vehicle compartment per unit time. If determining, based on the result of calculation, that it is difficult to raise the temperature inside the vehicle compartment, the vehicle 1A may cause the user terminal 600 to display the information recommending the user to board the vehicle 1A before the temperature inside the vehicle compartment reaches the set temperature set by the user.

In some embodiments, the vehicle 1A may cause the user terminal 600 to display the visualized graph of the information on the change in temperature inside the vehicle compartment, and the following comment: “The temperature outside the vehicle compartment is currently −25° C. Since the temperature outside the vehicle compartment is very low, the time necessary for the temperature inside the vehicle compartment to reach the set temperature will be very long. You are recommended to board the vehicle before the temperature inside the vehicle compartment reaches the set temperature. Boarding the vehicle before the temperature inside the vehicle compartment reaches the set temperature helps to largely reduce the fuel consumption and electric consumption, resulting in a reduction in CO₂ emission.”

This allows the user to know that it will take a long time for the temperature inside the vehicle compartment to reach the set temperature.

The vehicle 1A may recommend the user to depart earlier by causing the user terminal 600 to display the comment recommending the user to board the vehicle 1A before the temperature inside the vehicle compartment reaches the set temperature set by the user.

This helps to reduce the energy consumed before the start of traveling, resulting in reductions in CO₂ emission, electric consumption, and fuel consumption.

### Third Example Embodiment

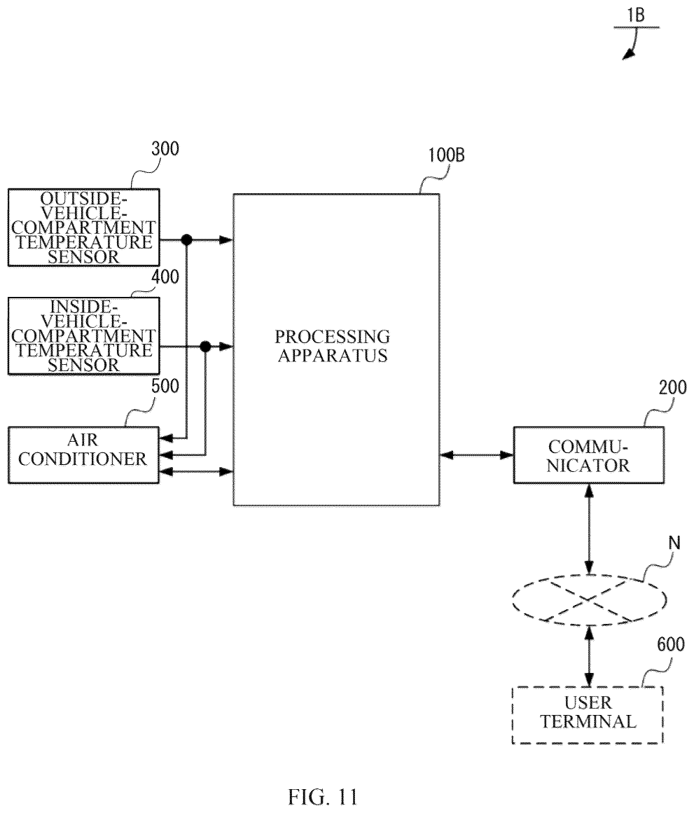

A vehicle 1B according to a third example embodiment will now be described with reference to FIGS. 11 to 14.

Note that the elements denoted with the same reference numerals as those in the first example embodiment have configurations similar to those in the first example embodiment, and a description thereof is omitted.

### <Configuration of Vehicle 1B>

As illustrated in FIG. 11, the vehicle 1B according to the present example embodiment may include a processing apparatus 100B, the communicator 200, the outside-vehicle-compartment temperature sensor 300, the inside-vehicle-compartment temperature sensor 400, and the air conditioner 500.

### <Configuration of Processing Apparatus 100B>

The processing apparatus 100B includes one or more processors and one or more memories communicably coupled to the one or more processors.

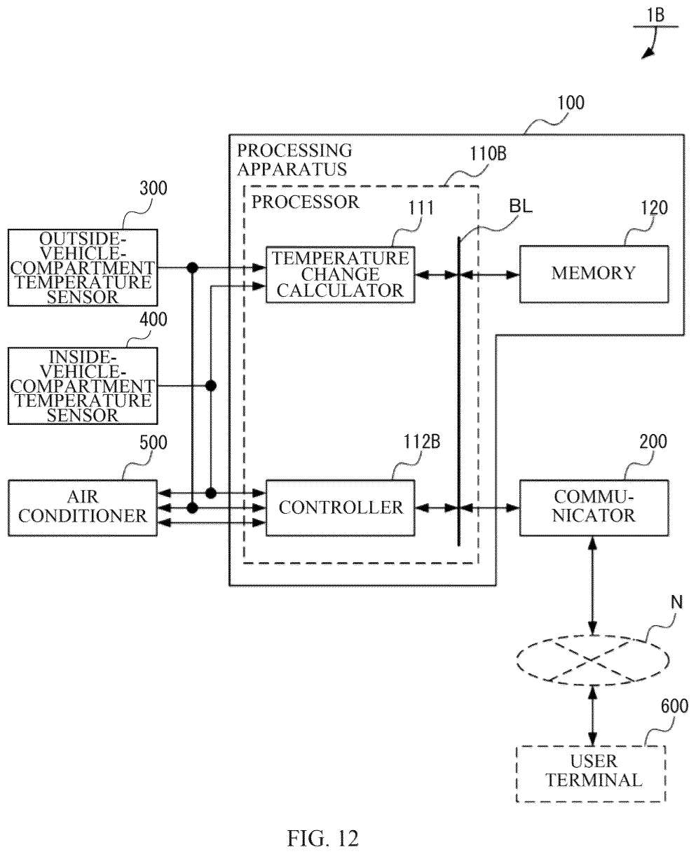

In the present example embodiment, the processing apparatus 100B may include a processor 110B and the memory 120, as illustrated in FIG. 12.

### <Configuration of Processor 110B>

As illustrated in FIG. 12, the processor 110B includes the temperature change calculator 111 and a controller 112B.

The components in the processor 110B, the memory 120, and the communicator 200 may send and receive various kinds of information via the bus line BL.

In the present example embodiment, when receiving the request to activate the air conditioner 500 and the set temperature information from the user terminal 600 via the communicator 200, the controller 112B may output the request to activate the air conditioner 500 and the set temperature information to the air conditioner 500.

In the present example embodiment, when receiving the request to activate the air conditioner 500 and the set temperature information from the user terminal 600 via the communicator 200, the controller 112B may output the request to calculate the change in temperature and the set temperature information to the temperature change calculator 111.

In the present example embodiment, the controller 112B may generate the display information by visualizing the result of calculation received from the temperature change calculator 111.

If determining that the temperature inside the vehicle compartment will not reach the set temperature within a predetermined time, based on the change in temperature calculated by the temperature change calculator 111, the controller 112B may cause the display information (information on the change in temperature) generated as described above and the information recommending the user to board the vehicle 1B before the temperature inside the vehicle compartment reaches the set temperature to be notified to the user.

In the present example embodiment, the controller 112B may determine whether the temperature inside the vehicle compartment will reach the set temperature set by the user within the predetermined time (e.g., 20 minutes) after the start of activation of the air conditioner 500, by referring to the result of calculation of the change in temperature inside the vehicle compartment received from the temperature change calculator 111.

In the present example embodiment, if determining that the temperature inside the vehicle compartment will not reach the set temperature set by the user within the predetermined time (e.g., 20 minutes) after the start of activation of the air conditioner 500, the controller 112B may transmit the visualized information on the change in temperature inside the vehicle compartment and the information recommending the user to board the vehicle 1B before the temperature reaches the set temperature set by the user to the user terminal 600 via the communicator 200.

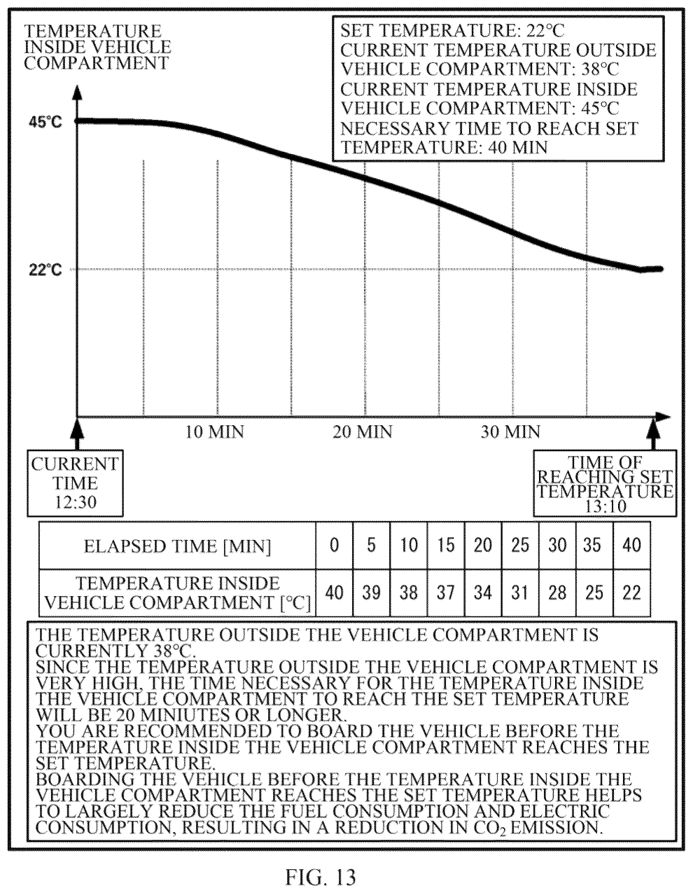

An exemplary image of the information that the controller 112B causes the user terminal 600 to display will now be described with reference to FIG. 13.

In the present example embodiment, the controller 112B may cause the user terminal 600 to display the set temperature (e.g., 22° C.) received from the user terminal 600.

In the present example embodiment, the controller 112B may cause the user terminal 600 to display the outside-vehicle-compartment temperature information (e.g., 38° C.) received from the outside-vehicle-compartment temperature sensor 300 upon the request to activate the air conditioner 500 being outputted.

In the present example embodiment, the controller 112B may cause the user terminal 600 to display the inside-vehicle-compartment temperature information (e.g., 45° C.) received from the inside-vehicle-compartment temperature sensor 400 upon the request to activate the air conditioner 500 being outputted.

In the present example embodiment, the controller 112B may cause the user terminal 600 to display the time (e.g., 40 minutes) necessary for the temperature inside the vehicle compartment to reach the set temperature set by the user.

In the present example embodiment, the controller 112B may cause the user terminal 600 to display the information on the time of reception of the request to activate the air conditioner 500 from the user terminal 600 and the information on the time of reaching of the temperature inside the vehicle compartment to the set temperature set by the user.

In the present example embodiment, the controller 112B may cause the user terminal 600 to display the following comment: “The temperature outside the vehicle compartment is currently 38° C. Since the temperature outside the vehicle compartment is very high, the time necessary for the temperature inside the vehicle compartment to reach the set temperature will be 20 minutes or longer. You are recommended to board the vehicle before the temperature inside the vehicle compartment reaches the set temperature. Boarding the vehicle before the temperature inside the vehicle compartment reaches the set temperature helps to largely reduce the fuel consumption and electric consumption, resulting in a reduction in CO₂ emission.”

### <Flow of Process to be Executed by Vehicle 1B>

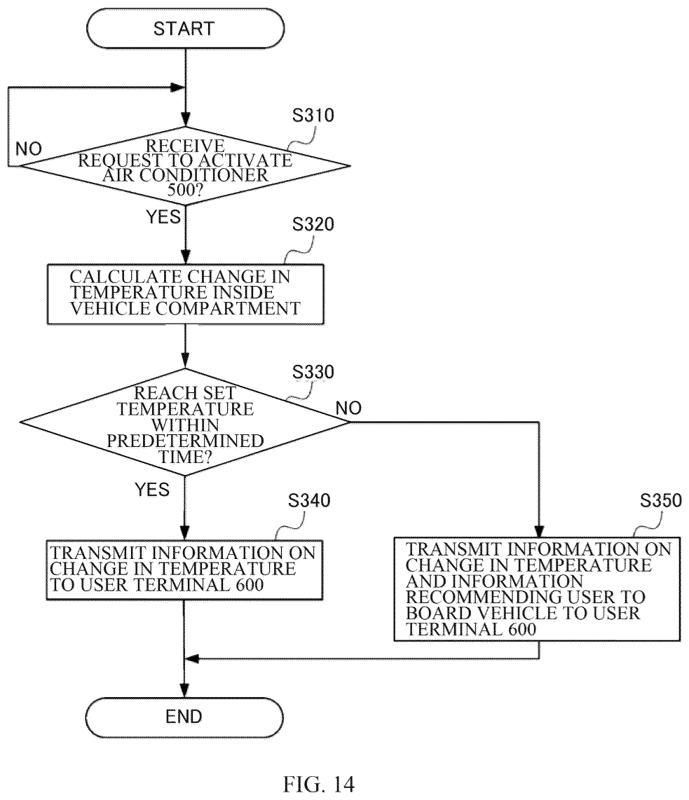

An exemplary flow of the process to be executed by the vehicle 1B will now be described with reference to FIG. 14.

The controller 112B may determine whether the request to activate the air conditioner 500 has been received from the user terminal 600 (Step S310).

If determining that the request to activate the air conditioner 500 has not been received from the user terminal 600 (Step S310: NO), the controller 112B may return the process to a stand-by mode.

If determining that the request to activate the air conditioner 500 has been received from the user terminal 600 (Step S310: YES), the controller 112B may cause the process to proceed to Step S320.

The controller 112B may cause the temperature change calculator 111 to calculate the change in temperature inside the vehicle compartment (Step S320) and cause the process to proceed to Step S330.

The controller 112B may determine whether the temperature inside the vehicle compartment will reach the set temperature set by the user within the predetermined time, by referring to the change in temperature inside the vehicle compartment calculated in Step S320 (Step S330).

If determining that the temperature inside the vehicle compartment will reach the set temperature set by the user within the predetermined time, by referring to the change in temperature inside the vehicle compartment calculated in Step S320 (Step S330: YES), the controller 112B may cause the process to proceed to Step S340.

If determining that the temperature inside the vehicle compartment will not reach the set temperature set by the user within the predetermined time, by referring to the change in temperature inside the vehicle compartment calculated in Step S320 (Step S330: NO), the controller 112B may cause the process to proceed to Step S350.

If determining that the temperature inside the vehicle compartment will reach the set temperature set by the user within the predetermined time, by referring to the change in temperature inside the vehicle compartment calculated in Step S320 (Step S330: YES), the controller 112B may transmit the information on the change in temperature inside the vehicle compartment to the user terminal 600 via the communicator 200 (Step S340), and thereafter end the process.

If determining that the temperature inside the vehicle compartment will not reach the set temperature set by the user within the predetermined time, by referring to the change in temperature inside the vehicle compartment calculated in Step S320 (Step S330: NO), the controller 112B may transmit the information recommending the user to board the vehicle 1B before the temperature inside the vehicle compartment reaches the set temperature set by the user, to the user terminal 600 via the communicator 200 (Step S350), and thereafter end the process.

### <Workings and Effects>

As described above, if determining that the temperature inside the vehicle compartment will not reach the set temperature within the predetermined time, based on the change in temperature calculated by the temperature change calculator 111, the controller 112B of the vehicle 1B according to the present example embodiment may cause the information recommending the user to board the vehicle 1B before the temperature inside the vehicle compartment reaches the set temperature to be notified to the user.

In a case where the air conditioner 500 of the vehicle 1B is activated when being parked in the hot summer sun or in the winter snow, the time necessary for the temperature inside the vehicle compartment to reach the set temperature will be very long due to an influence of the outside temperature or another factor.

Accordingly, if determining that the temperature inside the vehicle compartment will not reach the set temperature set by the user within the predetermined time, by referring to the change in temperature inside the vehicle compartment calculated by the temperature change calculator 111, the vehicle 1B may cause the user terminal 600 to display the information on the change in temperature inside the vehicle compartment and the information recommending the user to board the vehicle 1B before the temperature inside the vehicle compartment reaches the set temperature set by the user.

In some embodiments, the vehicle 1B may cause the user terminal 600 to display the visualized graph of the information on the change in temperature inside the vehicle compartment, and the following comment: “The temperature outside the vehicle compartment is currently 38° C. Since the temperature outside the vehicle compartment is very high, the time necessary for the temperature inside the vehicle compartment to reach the set temperature will be 20 minutes or longer. You are recommended to board the vehicle before the temperature inside the vehicle compartment reaches the set temperature. Boarding the vehicle before the temperature inside the vehicle compartment reaches the set temperature helps to largely reduce the fuel consumption and electric consumption, resulting in a reduction in CO₂ emission.”

This allows the user to know that it will take a long time for the temperature inside the vehicle compartment to reach the set temperature.

The vehicle 1B may recommend the user to depart earlier by causing the user terminal 600 to display the comment recommending the user to board the vehicle 1B before the temperature inside the vehicle compartment reaches the set temperature set by the user.

This helps to reduce the energy consumed before the start of traveling, resulting in reductions in CO₂ emission, electric consumption, and fuel consumption.

### Modification Example 1

The vehicles 1, 1A, and 1B described above may transmit the information indicating that the temperature inside the vehicle compartment has reached the set temperature to the user terminal 600 when determining that the temperature inside the vehicle compartment has reached the set temperature, based on the inside-vehicle-compartment temperature information received from the inside-vehicle-compartment temperature sensor 400.

This helps to reduce the energy to be wastefully consumed from the time of reaching of the temperature inside the vehicle compartment to the set temperature to the time of start of traveling of the vehicle 1, 1A, or 1B, resulting in reductions in CO₂ emission, electric consumption, and fuel consumption.

Such a transmission of the information indicating that the temperature inside the vehicle compartment has reached the set temperature to the user terminal 600 helps to shorten an unwanted waiting time of the user.

### Modification Example 2

The vehicles 1, 1A, and 1B described above may transmit the information on the change in temperature inside the vehicle compartment to the user terminal 600 when receiving the request to activate the air conditioner 500 and the set temperature information from the user terminal 600; however, the vehicles 1, 1A, and 1B may transmit the information on the change in temperature inside the vehicle compartment to the user terminal 600 and cause a display panel (e.g., meter indication panel) in the vehicle 1, 1A, or 1B to display the information on the change in temperature inside the vehicle compartment when the user in the vehicle 1 operates a component such as an operation panel of the air conditioner 500 to activate the air conditioner 500.

It is therefore possible to notify the user in the vehicle 1, 1A, or 1B of the information on the change in temperature inside the vehicle compartment.

### Modification Example 3

The temperature change calculator 111 described above may calculate the change in temperature inside the vehicle compartment per unit time after the activation of the air conditioner 500 by machine learning.

In some embodiments, the temperature change calculator 111 may calculate the change in temperature inside the vehicle compartment, using a trained model generated based on training data such as the change in temperature inside the vehicle compartment per unit time after the activation of the air conditioner 500 and the temperature outside the vehicle compartment.

This helps to calculate the change in temperature inside the vehicle compartment with high accuracy.

### Modification Example 4

The vehicle 1B described above may determine whether the temperature inside the vehicle compartment will reach the set temperature within the predetermined time; however, the vehicle 1B may determine whether the temperature inside the vehicle compartment will reach the set temperature within a time set by the user.

This allows the user to set any desired time acceptable as a waiting time.

In some embodiments, a program that causes the process to be performed by the temperature change calculator 111 and the controller 112, 112A, or 112B may be recorded on a non-transitory recording medium readable by a computer system. The vehicle 1, 1A, or 1B according to the example embodiments of the disclosure may be implemented by causing a memory of the computer system to load the program recorded in the non-transitory recording medium and causing the computer system to execute the program.

The computer system as used herein may encompass an operating system (OS) and hardware such as a peripheral device.

The “computer system” may encompass a website providing environment or a website displaying environment, when the computer system utilizes a World Wide Web (WWW) system.

The program may be transmitted from the computer system that contains the program in a device such as a storage device to another computer system via a transmission medium or by a carrier wave in a transmission medium.

The “transmission medium” designed to transmit the program may refer to a medium having a capability to transmit data, including: a network or a communication network such as the Internet; and a communication link or a communication line such as a telephone line.

The program may be directed to implement a part of the operation described above.

The program may be a so-called differential file or differential program designed to implement the operation by a combination of the program already recorded on the computer system.

Although some embodiments of the disclosure have been described in the foregoing by way of example with reference to the accompanying drawings, the disclosure is by no means limited to the embodiments described above. It should be appreciated that modifications and alterations may be made based on the vehicle 1, 1A, and 1B described above as the example embodiments of the disclosure by the persons skilled in the art without departing from the scope as defined by the appended claims. The disclosure is intended to include such vehicles according to the modifications and alterations in so far as they fall within the scope of the appended claims or the equivalents thereof.

It is understood that the persons skilled in the art can conceive of various modifications and variations within the scope of the disclosure and that these modifications and variations also fall within the scope of the disclosure.

For example, a modification to which some elements are added by the persons skilled in the art, a modification from which some elements are deleted by the persons skilled in the art, a modification the elements of which are changed in design by the persons skilled in the art, a modification to which some steps are added by the persons skilled, a modification from which some steps are deleted by the persons skilled in the art delete, and a modification the conditions of which are changed by the persons skilled in the art also fall within the scope of the disclosure as long as these modifications are in accordance with the gist of the disclosure.

Further, it should be understood that other effects apparently obtainable by the aspects of the disclosure described herein or other effects appropriately conceivable by the persons skilled in the art are provided by the disclosure.

Various other example embodiments are obtainable by appropriately combining the elements disclosed herein.

For example, some elements may be deleted from all the elements described in the example embodiments.

Further, the elements in different example embodiments may be combined as appropriate.

One or more of the temperature change calculator 111 and the controllers 112, 112A, and 112B illustrated in FIGS. 3, 8, and 12 are implementable by circuitry including at least one semiconductor integrated circuit such as at least one processor (e.g., a central processing unit (CPU)), at least one application specific integrated circuit (ASIC), and/or at least one field programmable gate array (FPGA). At least one processor is configurable, by reading instructions from at least one machine readable non-transitory tangible medium, to perform all or a part of functions of the temperature change calculator 111 and the controllers 112, 112A, and 112B illustrated in FIGS. 3, 8, and 12. Such a medium may take many forms, including, but not limited to, any type of magnetic medium such as a hard disk, any type of optical medium such as a CD and a DVD, any type of semiconductor memory (i.e., semiconductor circuit) such as a volatile memory and a non-volatile memory. The volatile memory may include a DRAM and a SRAM, and the nonvolatile memory may include a ROM and a NVRAM. The ASIC is an integrated circuit (IC) customized to perform, and the FPGA is an integrated circuit designed to be configured after manufacturing in order to perform, all or a part of the functions of the temperature change calculator 111 and the controllers 112, 112A, and 112B illustrated in FIGS. 3, 8, and 12.

1. A vehicle comprising:
an air conditioner configured to adjust a temperature inside a vehicle compartment of the vehicle to a set temperature set by a user;
a calculator configured to calculate a change in the temperature inside the vehicle compartment to reach the set temperature, based on a temperature outside the vehicle compartment and the temperature inside the vehicle compartment; and
a controller configured to cause information on the change in the temperature inside the vehicle compartment to be notified to the user.

2. The vehicle according to claim 1, wherein the controller is configured to, when receiving a request to activate the air conditioner from a user terminal owned by the user, cause the user terminal to display the information on the change in the temperature inside the vehicle compartment.

3. The vehicle according to claim 1, wherein
the controller is configure to,
when the temperature outside the vehicle compartment is lower than a predetermined temperature, calculate an amount of the change in the temperature inside the vehicle compartment per unit time, and
when the amount of the change in the temperature inside the vehicle compartment per unit time is less than or equal to a predetermined amount of change, cause information recommending the user to board the vehicle before the temperature inside the vehicle compartment reaches the set temperature to be notified to the user.

4. The vehicle according to claim 2, wherein
the controller is configure to,
when the temperature outside the vehicle compartment is lower than a predetermined temperature, calculate an amount of the change in the temperature inside the vehicle compartment per unit time, and
when the amount of the change in the temperature inside the vehicle compartment per unit time is less than or equal to a predetermined amount of change, cause information recommending the user to board the vehicle before the temperature inside the vehicle compartment reaches the set temperature to be notified to the user.

5. The vehicle according to claim 3, wherein the controller is configured to, when determining, based on the change in the temperature inside the vehicle compartment calculated by the calculator, that the temperature inside the vehicle compartment is not to reach the set temperature within a predetermined time, cause the information recommending the user to board the vehicle before the temperature inside the vehicle compartment reaches the set temperature to be notified to the user.

6. The vehicle according to claim 4, wherein the controller is configured to, when determining, based on the change in the temperature inside the vehicle compartment calculated by the calculator, that the temperature inside the vehicle compartment is not to reach the set temperature within a predetermined time, cause the information recommending the user to board the vehicle before the temperature inside the vehicle compartment reaches the set temperature to be notified to the user.

7. A vehicle comprising:
a processing apparatus; and
an air conditioner configured to adjust a temperature inside a vehicle compartment of the vehicle to a set temperature set by a user, wherein
the processing apparatus comprises
one or more processors, and
one or more memories communicably coupled to the one or more processors, and
the one or more processors are configured to
calculate a change in the temperature inside the vehicle compartment to reach the set temperature, based on a temperature outside the vehicle compartment and the temperature inside the vehicle compartment, and
cause information on the change in the temperature inside the vehicle compartment to be notified to the user.
